(19) United States
(12) Patent Application Publication
(10) Pub. No.: US 2026/0351916 A1
(43) Pub. Date: Nov. 5, 2026

(54) COMPONENT AND METHOD FOR PRODUCING A COMPONENT, IN PARTICULAR A PLUG CONNECTOR

(71) Applicant: Diehl Metal Applications GmbH, Berlin (DE)

(72) Inventors: Stephan Preuss, Berlin (DE); Christian Buchholzer, Stahnsdorf (DE)

(21) Appl. No.: 19/710,499

(22) Filed: Jun. 17, 2026

Related U.S. Application Data
(63) Continuation of application No. PCT/EP2024/084387, filed on Dec. 3, 2024.

(30) Foreign Application Priority Data
Dec. 20, 2023 (DE) 102023135976.2

(51) Int. Cl. H01R 43/16; H01B 1/02; H01B 5/00; H01B 13/32; H01R 13/03

(52) U.S. Cl. CPC H01R 43/16; H01B 1/02; H01B 13/32; H01R 13/03; H01B 5/002

(57) ABSTRACT

A method for producing a component, more particularly a plug connector, having at least one electrical contact portion with at least one base material and a silver layer applied to the at least one base material, includes applying at least one metallic barrier layer at least to portions of the silver layer. The barrier layer is configured to prevent ingress of extrinsic or extraneous substances, especially oxygen atoms, from the surroundings into the silver layer and/or to prevent egress or escape of base material, especially copper atoms, to a surface of the silver layer that faces the surroundings. A component, more particularly a plug connector, is also provided.

### CROSS-REFERENCE TO RELATED APPLICATION

This application is a continuation, under 35 U.S.C. § 120, of copending International Patent Application PCT/EP2024/084387, filed Dec. 3, 2024, which designated the United States; this application also claims the priority, under 35 U.S.C. § 119, of German Patent Application DE 10 2023 135 976.2, filed Dec. 20, 2023; the prior applications are herewith incorporated by reference in their entirety.

### FIELD AND BACKGROUND OF THE INVENTION

The invention relates to a component and a method for producing a component, in particular a plug-in connector, which component has at least one electrical contact section which has at least one base material and a silver layer applied to the at least one base material.

Such methods for producing components, in particular plug-in connectors, are known in principle from the prior art. Typically, a base material is provided, for example copper or a nickel layer applied to a copper layer or a copper volume, to which base material a silver layer is applied. In that regard, it is also known from the prior art that the silver layer in particular temperature ranges, in particular at temperatures of >150 °C, for example 180 °C, can allow inward diffusion or outward diffusion of atoms from the surroundings or from the base material, or the silver layer becomes permeable to such substances.

In the example of copper as base material, transfer of copper atoms from the base material through the silver layer to the surface of the silver layer that faces the surroundings can therefore take place, such that the copper atoms escape from the component and form a layer of copper oxide at the surface that can impair the surface properties of the component. If a base material chosen is nickel or a nickel layer which is applied to a further base material, for example copper, extrinsic atoms, specifically oxygen atoms, can penetrate through the silver layer which has become permeable into the component. The oxygen atoms that have penetrated can oxidize the nickel layer below the silver layer, such that delamination can occur between the individual layers of the component. In that case, detachment of the silver layer can occur, such that the properties of the component are likewise impaired.

In particular in applications in which the component, in particular the plug-in connector, is to be operated or used for a comparatively long time, for example 100-1000 hours, at an elevated temperature, for example above 150 °C or 180 °C, additional protection of the component is therefore necessary. The prior art proposes, for example, applying an additional tin layer between the silver layer and the base material in order to prevent the effects described above. However, that firstly reduces the mechanical properties of the component, such that a bending stress required in some applications can no longer be reliably achieved. In addition, the additional applying of the tin layer between the silver layer and the base material constitutes a complex adaptation of the manufacturing process, in particular of the manufacturing lines used, since the process stage in which the tin layer is to be applied has to be positioned, i.e. integrated into the process, between the established process stages in which the base material is processed or provided and in which the silver layer is applied to the component. In order to achieve that, complete modification of existing production lines is therefore necessary.

### SUMMARY OF THE INVENTION

It is accordingly an object of the invention to provide an improved component and a method for producing a component, in particular a plug connector, which overcome the hereinafore-mentioned disadvantages of the heretofore-known devices and methods of this general type and in which the method is less complex and allows improved components to be achieved.

With the foregoing and other objects in view there is provided, in accordance with the invention, a method of producing a component, in particular a plug-in connector. The component has an electrical contact section with which the component can be electrically contacted to at least one further component. For example, the component may form part of an at least two-part plug-in connector, for example a socket into which a plug can be inserted, or vice versa. The contact section has at least one base material and a silver layer applied to the at least one base material. The silver layer may in particular be applied directly to the base material, such that there is no intermediate layer between the base material and the silver layer. The base material may form a “core” of the component, around which or to which the silver layer is applied. In other words, the silver layer may surround the base material.

The invention is based on the finding that at least one metallic barrier layer is applied at least in sections to the silver layer and is configured to prevent ingress of extrinsic matter, in particular oxygen atoms, from the surroundings into the silver layer and/or escape of base material, in particular copper atoms, to a surface of the silver layer that faces the surroundings. In other words, the metallic barrier layer forms an outer layer or separating layer of a metal which is applied to the silver layer. The metallic barrier layer here prevents extrinsic matter from the surroundings from being able to penetrate into the silver layer, for example oxygen atoms that can penetrate or pass through the silver layer and can oxidize a layer of the base material beneath. The metallic barrier layer can likewise be used to prevent base material from escaping through the silver layer and being deposited on the surface of the silver layer that faces the surroundings, for example being able to form an oxide layer on the surface of the silver layer that faces the surroundings.

In particular, it is thereby advantageously possible to prevent achieve protection of the component from damage in temperature ranges in which the silver layer becomes permeable, for example above 150 °C, in particular 180 °C, since it is firstly impossible for extrinsic matter to penetrate into the silver layer since it remains separated from the silver layer by the metallic barrier layer. For example, oxygen atoms can only reach the metallic barrier layer, but cannot pass through the metallic barrier layer and penetrate into the silver layer. In other words, the metallic barrier layer separates the silver layer from the surroundings. Base material, for example copper atoms, is likewise prevented from escaping from the silver layer and thus being deposited on the surface of the silver layer and being oxidized there. Although the silver layer can become permeable to the base atoms or the base material in the temperature range described, the base material can only penetrate into the silver layer and cannot leave it in the direction of the surroundings, since the metallic barrier which separates the surroundings from the silver layer is applied there. In other words, it is possible to prevent formation of a deposit on the surface of the silver layer and delamination of the silver layer.

Advantageously, it is possible thereby to conserve the mechanical property of the plug-in connector as if it were produced solely from the base material and the silver layer, in particular without an interlayer introduced therebetween, since the metallic barrier layer can be applied externally to the silver layer. Furthermore, there is no need for a complex adaptation of existing production lines in which the introduction of an additional protective layer between the base material and the silver layer is performed, since the metallic barrier layer is applied to the silver layer and hence a further process stage can be added after the applying of the silver layer without altering the upstream process chain.

In one development of the method, the silver layer may be completely separated, in particular encapsulated, from the surroundings by the at least one barrier layer. In this configuration, the barrier layer may not only be applied locally to the silver layer, but the silver layer may be covered completely by the barrier layer or the barrier layer may be applied completely to the silver layer. In particular, this makes it possible to achieve the effect that the silver layer is fully encapsulated by the metallic barrier layer, such that the silver layer no longer has any contact with the surroundings but is fully enclosed by the barrier layer. This further prevents comparatively small regions of the silver layer into which extrinsic matter can enter or from which base material can escape from nevertheless having contact with the surroundings. In relation to the base material, the result may in particular be a symmetric construction of the component, where the base material is surrounded at least in sections by the silver layer and the silver layer is surrounded by the metallic barrier layer.

It may further be the case in the method that the at least one barrier layer is applied in the electrical contact section of the component, in particular a plug contact. The component, in particular the plug-in connector, may have a plurality of regions or sections, in which case it is also possible to provide, in addition to the electrical contact section by which the electrical contact is produced, a functional zone, for example a soldering zone and/or a pressing-in zone. The barrier layer is provided in particular in the electrical contact section of the component in which the silver layer is applied. In this case, it may specifically be the case that the at least one metallic barrier layer is applied exclusively to the silver layer. The applying of the metallic barrier layer may be limited to that region of the component on which the silver layer is applied. Other regions of the component, for example the functional zone described, therefore need not likewise be covered with the metallic barrier layer. In order to check the correct application of the metallic barrier layer, a start-up test of the component can be performed, for example in a sulfur-containing solution. Since the silver layer has a high affinity for sulfur, it can be determined whether the metallic barrier layer has been applied correctly via the occurrence of discoloration. If the surface of the component is not tarnished or no discoloration occurs, the metallic barrier layer reliably protects the silver layer beneath.

In the method described, the at least one metallic barrier layer may be applied in a layer thickness of less than 1 μm. Specifically, the layer thickness of the metallic barrier layer may be less than 250 nm, in particular less than 150 nm, preferably between 50 and 80 nm. It is likewise possible to apply more than one metallic barrier layer. In this case, the described layer thicknesses of the individual sublayers or of the individual barrier layers may reach the layer thicknesses mentioned overall.

Furthermore, in the method described, it may be the case that the at least one metallic barrier layer is applied in a second process step downstream of a first process step for applying the silver layer. In other words, the silver layer is applied to the base material in the first process step, with the metallic barrier layer being applied to the silver layer applied in a second process step. The terms “first process step” and “second process step” here refer in principle to any desired process steps in the method of producing the component, where any desired further process steps can be performed before the first process step, between the first process step and the second process step, and after the second process step. It is specifically ensured here that the metallic barrier layer is applied after the silver layer has been applied.

This offers the advantage in particular that, in an existing production plant in which the silver layer is applied to the base material, no further process station or no further process stage has to be integrated into the existing process prior to the applying of the silver layer, meaning that the production line does not have to be altered in a complex manner since no further process station has to be integrated between the providing of the base material and the applying of the silver layer. Instead, the corresponding process station or process stage may be downstream of the existing production process with respect to the applying of the silver layer. By way of example, the metallic barrier layer can be applied by deposition, in particular galvanic metal deposition or metal deposition without external current.

As described at the outset, base materials may in principle be any desired materials. In one embodiment of the method, the base material used in the component may be copper and/or a first base material and a second base material applied between the first base material and the silver layer may be used, where the second base material used may be nickel or white bronze or cobalt or gold or palladium. In other words, according to the first variant of the embodiment described, the base material used is copper, to which the silver layer is applied. In this case, there is specifically no further layer between the copper and the silver layer, and the silver layer is instead applied directly to the copper used as base material. As described above, the metallic barrier layer in this configuration prevents copper atoms from the base material from being able to pass through the silver layer at elevated temperatures and being deposited on the surface of the silver layer that faces the surroundings in order to form copper oxide there. Instead, the metallic barrier layer is positioned there, which prevents the base material from escaping.

In the second configuration described, any desired first base material can be used, for example likewise copper. The second base material used, which has been applied or is applied to the first base material and is thus between the first base material and the silver layer, may be nickel for example. In addition to nickel, the second base material used may also be white bronze, cobalt, gold or palladium, although nickel may be preferred. The nickel layer applied as second base material to the first base material, for example to the copper, can serve as a diffusion barrier for the copper used as the first base material or as an interlayer which provides wear protection. In any case, in the second embodiment, the metallic barrier layer can prevent extrinsic matter from being able to penetrate into the component from the surroundings. If the silver layer in a particular temperature range becomes permeable to extrinsic matter from the surroundings, in particular oxygen atoms, penetration into the silver layer is prevented by the barrier layer, such that the extrinsic matter does not reach the second base material and therefore cannot alter it, for example by oxidation. Specifically, the metallic barrier layer prevents oxygen atoms from being able to get into the silver layer which is permeable within the temperature range and from being able to oxidize the second base material beneath the silver layer, namely between the first base material and the silver layer, such that delamination of the silver layer can be reliably prevented.

Accordingly, a multitude of suitable metals, alloys, mixtures or compounds can be used for the metallic barrier layer. In one embodiment of the method, a depositable metal can be used for the at least one metallic barrier layer, in particular a metal configured to form an oxide layer with defined electrical contact resistance. It is thus possible in principle, for the method described herein, to use metals that are depositable, for example by galvanic deposition or deposition without external current. Advantageously, metals used are those having an oxide layer that forms a defined electrical contact resistance, for example metals having a specific resistivity of <0.1 ohm per m/mm², preferably less than 0.07 ohm per m/mm². Particular consideration may be given here to the alloy or the intermetallic phase into which the metallic barrier layer enters over time with the silver layer beneath.

In the method described, it may further be the case that the at least one metallic barrier layer includes at least one base metal layer, in particular including tin and/or indium and/or bismuth and/or chromium and/or nickel and/or cobalt and/or tungsten and/or zinc and/or antimony, in particular a silver-tin alloy and/or a nickel-tungsten alloy and/or a tin-nickel alloy and/or a nickel-phosphorus alloy, and/or in that the at least one metallic barrier layer includes at least one precious metal layer, in particular including gold and/or palladium and/or ruthenium and/or rhodium and/or platinum.

In principle, it is thus possible to use any desired base metal layer or precious metal layer, as described above, as the metallic barrier layer. In particular, it is also possible to use mixtures or alloys of the base metals, for example a silver-tin alloy containing between 60% and 90% silver. In particular, it is possible to use a nickel-tungsten alloy, where the tungsten content may be between 20 and 40%. Moreover, it is possible to use tin-nickel alloys with a proportion of 70% tin and 30% nickel to 30% tin and 70% nickel. In addition, it is possible to use a nickel-phosphorus alloy with 4% to 15% phosphorus.

With the objects of the invention in view, there is concomitantly provided a component, in particular a plug-in connector, which component has at least one electrical contact section which has at least one base material and a silver layer applied to the at least one base material, wherein the component has at least one metallic barrier layer which is applied at least in sections to the silver layer and is configured to prevent ingress of extrinsic matter, in particular oxygen atoms, from the surroundings into the silver layer and/or escape of base material, in particular copper atoms, to a surface of the silver layer that faces the surroundings.

The component described can be produced in particular by the method described above. In principle, all the advantages, details and features that have been described in relation to the method are entirely applicable to the component. The component thus has the features of a component produced by the method described above.

Other features which are considered as characteristic for the invention are set forth in the appended claims.

Although the invention is illustrated and described herein as embodied in a component and a method for producing a component, in particular a plug connector, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a basic diagrammatic, cross-sectional view of a component according to a first working example;

FIG. 2 is a basic cross-sectional view of a component according to a second working example; and

FIG. 3 is a basic flowchart of a method of producing a component.

### DETAILED DESCRIPTION OF THE INVENTION

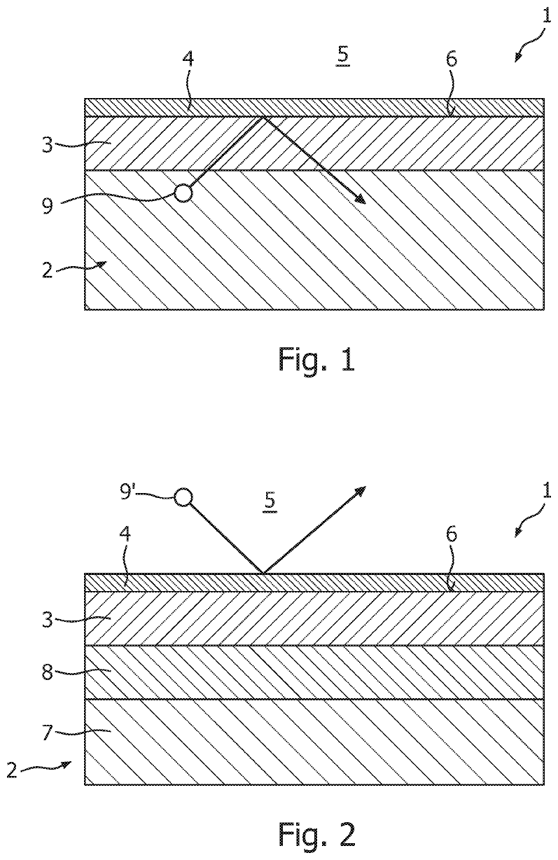

Referring now to the figures of the drawings in detail and first, particularly, to FIG. 1 thereof, there is seen a detail of a component 1, for example of a plug-in connector. The component 1 may form or include any part of a plug-in connector, for example a socket or a plug. The detail of the component 1 shown may relate in particular to an electrical contact section at which the component 1 can be electrically connected to a further component, for example the corresponding plug or the corresponding socket.

The component 1 has a base material 2, which may in principle be chosen as desired, and in this working example may, for example, be copper or contain copper. A silver layer 3 has been applied to the base material 2. A metallic barrier layer 4 has been applied in turn to the silver layer 3, in particular deposited on the silver layer 3. The metallic barrier layer 4 is configured to prevent ingress of extrinsic matter, for example oxygen atoms, from the surroundings 5 into the silver layer 3 and/or to prevent escape of base material 2, for example copper atoms 9, to a surface 6 of the silver layer 3 facing the surroundings 5.

In the working example shown, the barrier layer 4 is provided to prevent base material 2, specifically copper atoms 9 shown by way of example, from being able to reach the surface 6 of the silver layer 3 in order to escape there from the component 1 and to form an oxide layer, in particular copper oxide, on the surface 6. Instead, this is prevented by the metallic barrier layer 4 applied to the surface 6 of the silver layer 3, such that the copper atoms 9 cannot leave the silver layer 3 there.

If the component 1 is heated, in particular in temperature ranges above 150 °C, in which the silver layer 3 becomes permeable to the base material 2, it is ensured that the metallic barrier layer 4 forms the transition of the component 1 to the surroundings 5 and no oxide layer can form at the surface 6 of the silver layer 3 which is covered by the barrier layer 4; in particular, the copper atoms 9 cannot leave the silver layer at the surface 6.

An alternative embodiment of the component 1 is shown in FIG. 2. In that case, the component 1 in turn has a base material 2 which, in the second working example, includes a first base material 7 and a second base material 8. In principle, the base materials 7, 8 here too may be chosen as desired. Purely by way of example, the first base material 7 used may again be copper, as described above, although any other desired base material 7 may likewise be used.

In the working example shown, the second base material 8 used is nickel, although white bronze, cobalt, gold or palladium could likewise be used. As described, the silver layer 3 has been applied to the base material 2, specifically in this case to the second base material 8, and the metallic barrier layer 4 is in turn applied, in particular deposited, on the silver layer 3. Illustrated by way of example is extrinsic matter in the form of an oxygen atom 9′. The metallic barrier layer 4 protects the silver layer 3 from the surroundings 5, such that penetration of oxygen atoms 9′ or any other extrinsic matter into the silver layer 3 is prevented.

Even in temperature ranges, in particular >150 °C, for example 180 °C, which can also be maintained over a relatively long period of time and in which the silver layer 3 becomes permeable to extrinsic matter, for example oxygen atoms 9′, it is ensured that the extrinsic matter cannot penetrate into the silver layer 3 and therefore cannot pass through it either, but is held back by the metallic barrier layer 4. In particular, this can prevent such extrinsic matter from being able to pass through the silver layer 3 to the second base material 8.

If nickel is used as the second base material 8, oxidizing of the nickel layer by the barrier layer 4 is prevented since, without the barrier layer 4, it would be possible for the oxygen atoms 9′ to pass through the silver layer 3, such that they could oxidize the second base material 8, which could lead to delamination of the silver layer 3. Such a process is reliably prevented by the metallic barrier layer 4, since the latter delimits the silver layer 3 from the surroundings 5.

In the embodiments shown, it may be the case that the barrier layer 4 is applied over the whole area or completely to the silver layer 3, such that the latter fully encapsulates the silver layer 3 with respect to the surroundings 5. As can be seen, the metallic barrier layer 4 can be applied as the last layer of the component 1 or after the silver layer 3 has been applied to the component 1. Deposition or, in general, application of the barrier layer 4 can thus be added to existing processes in which no barrier layer 4 has been applied as yet without having to alter the process line there in a complex manner. Instead, the barrier layer 4 can be applied in a process step downstream of the existing process, for example by way of further processing.

The metallic barrier layer 4 may have a defined layer thickness, which may be less than 1 μm, for example. In this case, the metallic barrier layer 4 can be applied in a thickness of <250 nm, in particular <150 nm, preferably between 50 and 80 nm.

As described, the component 1 may have different sections, where, in addition to the electrical contact section shown in the detail in FIGS. 1 and 2, a functional section may also be provided, for example a soldering zone or a pressing-in zone. In this case, the application of the metallic barrier layer 4 to the contact section may be limited, in particular to the silver layer 3 on the contact section.

In the working example shown, a depositable metal is used for the forming of the metallic barrier layer 4. In particular, a metal having an oxide layer that can be formed with defined electrical contact resistance is used. Particular consideration may be given here to the intermetallic phase between the metallic barrier layer 4 and the silver layer 3 with respect to electrical contact resistance. In principle, the metallic barrier layer 4 may also be a precious metal layer, for example including gold and/or palladium and/or ruthenium and/or rhodium and/or platinum, although a base metal layer may be preferred for reasons of cost, in particular including tin and/or indium and/or bismuth and/or chromium and/or nickel and/or cobalt and/or tungsten and/or zinc and/or antimony, in particular a silver-tin alloy and/or a nickel-tungsten alloy and/or a tin-nickel alloy and/or a nickel-phosphorus alloy.

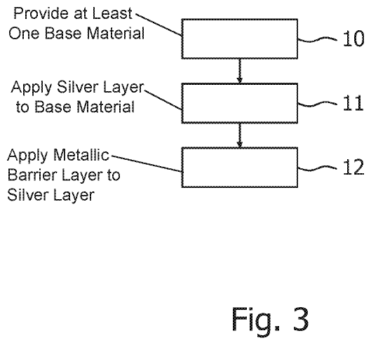

FIG. 3 shows a schematic flow diagram of a method of producing a component 1, specifically an above-described component 1 according to the first or the second embodiment. In a first step 10 of the method, the base material 2 is provided, for example according to FIG. 1 as a continuous layer or a multitude of layers of a single material, for example copper. Alternatively, for example according to FIG. 2, a base material 2 including a first base material 7 and a second base material 8 may be provided. For example, the second base material 8 may be deposited on the first base material 7. For example, copper may thus be used as the first base material 7, and nickel may be used as the second base material 8 applied to the first base material 7.

In both cases, the silver layer 3 is applied to the base material 2 in a second step 11 of the method, namely either to the base material 2 according to FIG. 1 or to the second base material 8 of the base material 2 according to FIG. 2. Alternatively, instead of steps 10 and 11, the component 1 may be provided in already constructed form, i.e. including the base material 2 and the silver layer 3, such that the component can be provided as a “semifinished product.”

Irrespective of the production or provision of the base material 2 and of the silver layer 3 applied thereto, the metallic barrier layer 4 is applied to the silver layer 3 in step 12. The barrier layer 4 may in particular be applied in such a way that the whole surface 6 of the silver layer 3 by which the silver layer 3 faces the surroundings 5 is covered by the barrier layer 4. As a result, the silver layer 3 is completely encapsulated by the barrier layer 4 and hence separated from the surroundings 5.

It can be seen that step 12 can be joined as desired onto the preceding production process. In particular, it is unnecessary to modify an already established production process in which a process station provided for application of the barrier layer 4 has to be inserted between two process stations used for the existing production of a component 1. Instead, the component 1, which includes the silver layer 3 and the base material 2 so far, can be supplemented by step 12, in which the metallic barrier layer 4 is applied to the silver layer 3. In other words, the barrier layer 4 is applied after the application of the silver layer 3 in the process sequence.

The advantages, details and features shown in the individual working examples are interchangeable, mutually applicable and mutually combinable.

1. A method of producing a component or a plug-in connector, the method comprising:
providing a component including at least one electrical contact section having at least one base material and a silver layer applied to the at least one base material; and
applying at least one metallic barrier layer at least in sections to the silver layer for preventing at least one of ingress of extrinsic matter from surroundings into the silver layer or escape of base material to a surface of the silver layer facing the surroundings.

2. The method according to claim 1, which further comprises using the at least one metallic barrier layer to prevent at least one of ingress of oxygen atoms from the surroundings into the silver layer or escape of copper atoms to the surface of the silver layer facing the surroundings.

3. The method according to claim 1, which further comprises using the at least one metallic barrier layer to completely separate or encapsulate the silver layer relative to the surroundings.

4. The method according to claim 1, which further comprises applying the at least one metallic barrier layer in an electrical contact section of the component.

5. The method according to claim 4, which further comprises providing a plug contact as the component.

6. The method according to claim 1, which further comprises applying the at least one metallic barrier layer exclusively on the silver layer.

7. The method according to claim 1, which further comprises applying the at least one metallic barrier layer in a layer thickness of <1 μm.

8. The method according to claim 1, which further comprises applying the at least one metallic barrier layer in a layer thickness of <250 nm.

9. The method according to claim 1, which further comprises applying the at least one metallic barrier layer in a layer thickness of <150 nm.

10. The method according to claim 1, which further comprises applying the at least one metallic barrier layer in a layer thickness of 50-80 nm.

11. The method according to claim 1, which further comprises applying the at least one metallic barrier layer in a second process step after a first process step for applying the silver layer.

12. The method according to claim 1, which further comprises at least one of:
providing copper as the base material, or
providing a first base material and a second base material applied between the first base material and the silver layer, as the base material, wherein nickel or white bronze or cobalt or gold or palladium is the second base material.

13. The method according to claim 1, which further comprises using a depositable metal for the at least one metallic barrier layer.

14. The method according to claim 13, which further comprises providing a metal configured to form an oxide layer with defined electrical contact resistance as the at least one metallic barrier layer.

15. The method according to claim 1, which further comprises:
selecting as the at least one metallic barrier layer at least one base metal layer including at least one of tin or indium or bismuth or chromium or nickel or cobalt or tungsten or zinc or antimony, or
selecting as the at least one metallic barrier layer at least one of a silver-tin alloy or a nickel-tungsten alloy or a tin-nickel alloy or a nickel-phosphorus alloy, or
selecting as the at least one metallic barrier layer at least one precious metal layer including gold or palladium or ruthenium or rhodium or platinum.

16. A component or a plug-in connector, comprising:
at least one electrical contact section having at least one base material and a silver layer applied to said at least one base material; and
at least one metallic barrier layer applied at least in sections to said silver layer, said at least one metallic barrier layer configured to prevent at least one of ingress of extrinsic matter from surroundings into said silver layer or escape of base material to a surface of said silver layer facing the surroundings.

17. The component according to claim 16, wherein said at least one metallic barrier layer is configured to prevent at least one of ingress of oxygen atoms from the surroundings into said silver layer or escape of copper atoms to said surface of said silver layer facing the surroundings.
